(19) United States
(12) Patent Application Publication
(10) Pub. No.: US 2008/0100082 A1
(43) Pub. Date: May 1, 2008

(54) Floor panel having a reinforcing structure in a vehicle

(76) Inventor: Gyeong Hoon Heo, Gwangju (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/652,257

(22) Filed: Jan. 10, 2007

(30) Foreign Application Priority Data
Oct. 31, 2006 (KR) 10-2006-0106820

(51) Int. Cl. B60N 3/12

(52) U.S. Cl. 296/37.16

(57) ABSTRACT

A floor panel for a vehicle having a reinforcing structure includes: a luggage room which is formed at the rear of a passenger space and holds at least one piece of luggage; a floor box which is formed at a floor of the luggage room and receives at least one small piece of luggage; a main panel which is made of poly-propylene material; sub panels which are respectively coupled to an upper surface and a lower surface of the main panel and are made of glass mat thermoplastic (GMT) material; and panel protectors which are respectively coupled to outer surfaces of the sub panels and are made of nonwoven fabric. The floor panel is flat, plate shaped and opens and closes the floor box.

### CROSS-REFERENCE TO RELATED APPLICATION

This application claims priority to Korean Patent Application No. 10-2006-0106820 filed in the Korean Intellectual Property Office on Oct. 31, 2006, the disclosure of which is incorporated herein by reference.

### BACKGROUND OF THE INVENTION

(a) Field of the Invention

The present invention relates to a floor panel for a vehicle having a reinforcing structure.

(b) Description of the Related Art

Generally, a recreational vehicle (RV) is a vehicle which has a good inner space efficiency so as to hold more passengers and goods. An RV includes vehicles such as a minivan, a sports utility vehicle (SUV), a wagon, ect.

The minivan is called a multi purpose vehicle (MPV) in Europe, and indicates passenger vehicles which can hold between seven to nine passengers. The SUV is a vehicle suitable for sports activity and movement. The wagon is a vehicle which is based on a sedan and has an enlarged luggage room.

Generally, the RV vehicle includes a luggage room for holding goods at the rear of a passenger vehicle.

However, in the conventional floor panel, expensive glass mat thermoplastic (GMT) material, which is located in the sub panels, has a thickness which is three times as thick as the finished product. This may increase manufacturing cost.

Furthermore, if a separate steel reinforcing member is used in the floor panel, the structure and manufacturing process can become complicated.

Additionally, since the floor panel is at least several millimeters thicker, the floor panel is manufactured using a single material resulting in a deterioration of heat insulation and noise in a vehicle.

In addition, since the nonwoven fabric is attached to the floor panel by bonding process, the smell of adhesive may cause discomfort to occupants.

Therefore, there is a need to provide a floor panel which has great strength, small weight and improved heat insulation.

### SUMMARY OF THE INVENTION

The present invention provides a floor panel for a vehicle which has greater strength, small weight, and improved heat insulation.

In one embodiment, the present invention provides a floor panel for a vehicle having an improved reinforcing structure comprises: a luggage room which is formed at the rear of a passenger space and holds at least one piece of luggage; a floor box which is formed at the floor of the luggage room and receives smaller pieces of luggage; a main panel which is made of poly-propylene material; sub panels which are respectively coupled to an upper surface and a lower surface of the main panel and are made of glass mat thermoplastic (GMT) material; and panel protectors which are respectively coupled to outer surfaces of the sub panels and are made of nonwoven fabric. The floor panel is flat, plate-shaped and opens and closes the floor box.

In an exemplary embodiment, the main panel has a honeycomb structure.

In another exemplary embodiment, the sub panels may be formed to have a thickness of about 1 mm.

In another exemplary embodiment, the panel protectors may be attached to the sub panels by heat and pressure.

### BRIEF DESCRIPTION OF THE DRAWINGS

FIG. 1 is a perspective view of a conventional luggage room of a recreational vehicle (RV).

FIG. 2 is a perspective view showing a state in which a floor panel according to FIG. 1 is opened.

FIG. 3 is a plain view showing a rear surface of a floor panel according to FIG. 1.

FIG. 4 is an enhanced perspective view schematically showing a floor panel for a recreational vehicle according to an exemplary embodiment of the present invention.

FIG. 5 is a cross sectional view of a floor panel of FIG. 4.

FIG. 6 is a perspective view showing a handle of a floor panel according to an exemplary embodiment of the present invention.

FIG. 7 is a cross sectional view showing an opened structure of a floor panel according to an exemplary embodiment of the present invention.

### DESCRIPTION OF REFERENCE NUMERALS INDICATING PRIMARY ELEMENTS IN THE DRAWINGS

100: vehicle

112: floor

120: floor box

132: main panel

136: panel protector

110: luggage room

114: locker

130: floor panel

134: sub panel

138: handle

### DETAILED DESCRIPTION OF THE INVENTION

An exemplary embodiment of the present invention will hereinafter be described in detail with reference to the accompanying drawings.

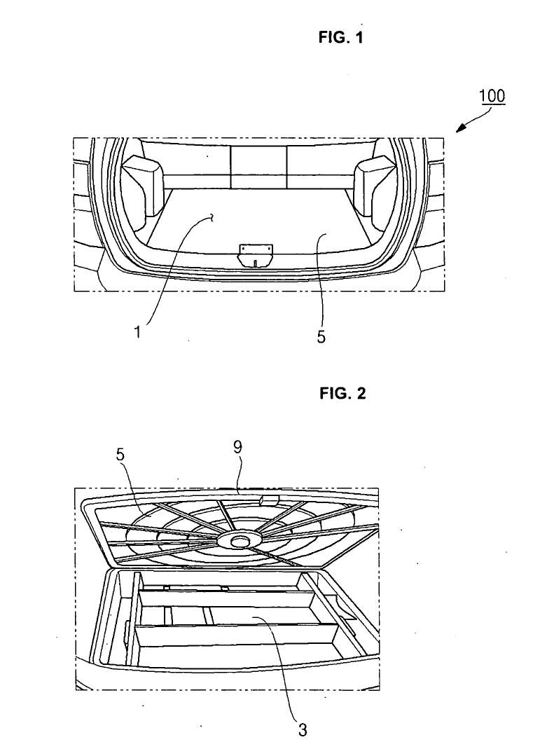

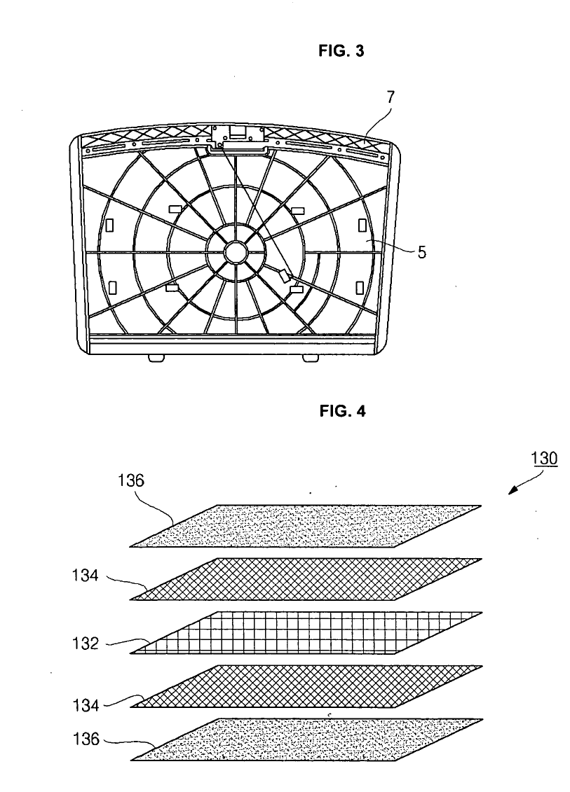

As shown in FIG. 1 to FIG. 3, a floor panel 5 opens and closes a floor box 3 which is formed in a luggage room I at the rear portion of a vehicle. The floor panel 5 is formed by forming a base panel by applying a press to a glass mat thermoplastic (GMT) material or by injection molding of poly-propylene. Then a reinforcing member 7 of steel material is coupled to a rear side thereof so as to reinforce strength. A nonwoven fabric 9 is attached by a bonding process to an upper surface of the floor panel 5 so as to absorb impact by a luggage.

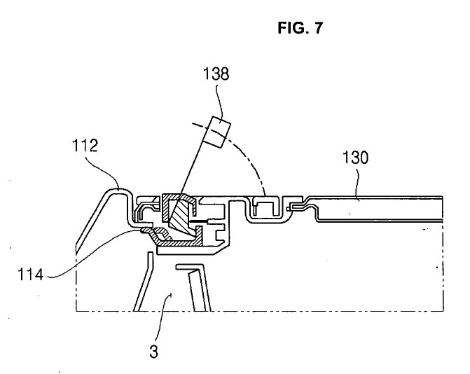

As shown in FIG. 4 and FIG. 7, a floor panel 130 according to an exemplary embodiment of the present invention opens and closes a floor box 3 which is formed on a floor 112 of a luggage room I in a vehicle 100. The floor panel 130 forms a portion of the floor 112 of the luggage room 1.

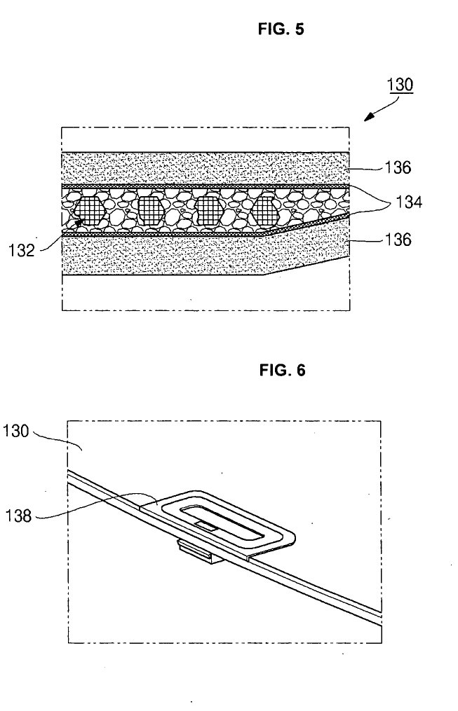

As shown in FIG. 4 and FIG. 5, sub panels 134 are respectively coupled to an upper surface and a lower surface of a main panel 132. Panel protectors 136 are respectively coupled to outer sides of the sub panels 134. These are closely adhered to each other so as to form the floor panel 130 in a plate shape. A handle 138 is formed at a side of the floor panel 130.

The main panel 132 is made of poly-propylene (PP). In a preferred embodiment, the main panel is formed in a stable honeycomb structure so as to enhance planarity.

Poly-propylene is a type of plastic material having excellent durability, high strength, and small weight. Furthermore, poly-propylene can be easily manufactured due to thermoplasticity. Since the main panel 132 is made of polypropylene which is shaped in a honeycomb structure, the main panel 132 has excellent durability and planarity.

Since the main panel is formed in the honeycomb structure, the main panel forms a closed hollow space. The main panel has an air layer which provides good thermal insulation and a small weight.

As shown in FIG. 4 and FIG. 5, the sub panel 134 is made of glass mat thermoplastic (GMT) material having a thickness of about 10 mm, more preferable about 5 mm, and most preferable about 1 mm. GMT is a type of composite material. In a preferred embodiment, GMT is a thermoplastic composite. Thermoplastic is a material that is plastic or deformable, melts to a liquid when heated and freezes to a brittle, glassy state when cooled. Most thermoplastic are high molecular weight polymers. GMT material is plastic material which has great strength, small weight, easily formed, and can be recycled. GMT material is expensive. If a great amount of GMT material is used, manufacturing cost is substantially increased. In an exemplary embodiment of the present invention, GMT material is used in a thin plate having a thickness about 1 mm, thereby reducing the amount of GMT. However, since GMT material is used together with poly-propylene having great strength, the desired strength for the floor panel 130 can be maintained even through GMT material is used in a thin plate.

The panel protectors 136 are coupled to the sub panels 134 so as to prevent impact and scratch by a luggage, and may be made of nonwoven fabric.

The nonwoven fabric is made by arranging fabrics in parallel direction or perpendicular direction. It is widely used for industrial use. Nonwoven fabric is typically manufactured by putting small fibers together in the form of a sheet, then binding them mechanically, with an adhesive or thermally. The nonwoven fabric does not have vertical or horizontal orientations since fabrics are interwined. In addition, since a space is formed among fabrics, the nonwoven fabric can easily absorb impact.

The panel protectors 136 are pressed while heat and pressure are applied so as to be attached to surfaces of the sub panels 134. Since the panel protectors 136 which are made of nonwoven fabric are attached without bonding process, the smell of the floor panel can be improved while reducing manufacturing cost.

Meanwhile, as shown in FIG. 6 and FIG. 7, the handle 138 is formed at a side of the floor panel 130, so that the floor panel 130Q opens and closes the floor box 3.

If the handle 138 is pulled in an upward direction of the floor panel 130, the floor panel 130 is opened while a locker 114 which is fixed to the floor panel 130 is pushed. The floor panel 130 can be easily opened and closed by this process.

Since the floor panel 130 is formed in a triple reinforcing structure of the main panel 132, the sub panel 134, and the panel protector 136, it does not sag or twist when a heavy piece of luggage is laid thereon. Since the floor panel 130 forms closed spaces, it can effectively isolate noises.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A floor panel for a vehicle having a reinforcing structure, comprising:
a luggage room which is formed at the rear of a passenger space and holds at least one piece of luggage;
a floor box which is formed at a floor of the luggage room and receives at least a one small piece of luggage; and
a main panel which is made of poly-propylene material;
a plurality of sub panels which are respectively coupled to an upper surface and a lower surface of the main panel and are made of glass mat thermoplastic (GMT) material; and
a plurality of panel protectors which are respectively coupled to outer surfaces of the sub panels and are made of nonwoven fabric,
wherein the floor panel opens and closes the floor box.

2. The floor panel of claim 1, wherein the main panel is a honeycomb structure.

3. The floor panel of claim 1, wherein the sub panels are formed to have a thickness of about 1 mm.

4. The floor panel of claim 1, wherein the panel protectors are attached to the sub panels by heat and pressure.
